(19) United States
(12) Patent Application Publication
(10) Pub. No.: US 2006/0072618 A1
(43) Pub. Date: Apr. 6, 2006

(54) Packet-sending communication apparatus with forwarding-address automatic-recognition function, communication system and programs thereof

(76) Inventors: Hirotaka Moribe, Yokohama (JP); Takeshi Asahi, Fujisawa (JP); Mika Mizutani, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/239,205

(22) Filed: Sep. 30, 2005

(30) Foreign Application Priority Data
Oct. 1, 2004 (JP) 2004-289920

(51) Int. Cl. H04J 3/24

(52) U.S. Cl. 370/474

(57) ABSTRACT

A communication apparatus capable of automatic recognition between remote communication apparatuses using a SSDP packet according to UPnP specification without changing the existing UPnP stack is disclosed. The communication apparatuses connected to communication networks each comprise a data receiver adapted to receive the data from the communication networks, a policy determining unit adapted to set the rule for determining the processing of the data received by the data receiver, a SSDP determining unit for determining the data processing with reference to the policy determining unit, a SSDP packet decapsulation unit adapted to process and decapsulate the encapsulated SSDP packet, a forwarding address list adapted to register the address of the remote communication apparatus, a SSDP packet encapsulation unit for processing and encapsulating the SSDP packet, and a remote apparatus information cache for storing the information of the remote communication apparatus.

### CLAIM OF PRIORITY

The present application claims priority from Japanese application JP2004-289920 filed on Oct. 1, 2004, the content of which is hereby incorporated by reference into this application.

### BACKGROUND OF THE INVENTION

1. Field of the Invention

This invention relates to a communication apparatus having the function of automatic recognition of the forwarding address using a SSDP (Simple Service Discovery Protocol) packet according the UPnP (Universal Plug and Play) specification, a communication system using the communication apparatus, and a program for executing the function of the communication system.

2. Description of the Related Art

One of the techniques in which a communication apparatus on a network automatically recognizes and uses the presence and functions of other communication apparatuses on the network without demanding the sophisticated knowledge or complicated setting and operation of the user is the UPnP (Universal Plug and Play) specification. Refer to “Contributing Members of the UPnP Forum ‘UPnP Device Architecture 1.0 Version 1.0.1’ UPnP Forum 2003”.

According to the UPnP specification, a communication apparatus first uses the protocol called SSDP (Simple Service Discovery Protocol) to advertise the presence of itself to other communication apparatuses on the same network. As a result, each communication apparatus can recognize the presence of the other communication apparatuses while at the same time advertising the presence of itself to the other communication apparatuses.

SSDP is a protocol with the HTTP (Hypertext Transfer Protocol) header extended for simple search of resources. According to SSDP, in order to search for the resources in the local network, the SSDP packet using a multicast address is transmitted to advertise the presence of a communication apparatus to other communication apparatuses in the local network.

The multicast address used by SSDP is the site local-scope multicast address reserved by IANA (Internet Assigned Numbers Authority) called “239.255.255.250”.

The SSDP packet contains the link to the device description document described in XML (extensible Markup Language) defined by Yaron Y. Goland: “Simple Service Discovery Protocol/1.0 Operating without an Arbiter” INTERNET DRAFT 1999. This device description document also contains the URL for accessing the service type defined by UPnP Forum in addition to the device type, the maker name and the model name, and by use of this URL, the service description document containing the detailed description of the service functions in XML can be acquired.

In view of the fact that according to SSDP using the UPnP specification, the communication apparatus advertises the presence thereof using the site local-scope multicast address called “239.255.255.250”, however, only the communication apparatuses existing on the network having a router adapted for multicasting can be automatically recognized to the extent that the SSDP packet is transferred in the case where only a part of the routes to the target communication apparatus has the router adapted for multicasting. Specifically, the communication system according to the UPnP specification can conduct the communication only within the network for multicast communication using the SSDP packet, and cannot communicate with other networks beyond the particular network.

Also, in order to suppress the excessive traffic, the TTL (Time To Live) of the SSDP packet is normally set to about 4 beyond which a target communication apparatus cannot be automatically recognized.

Thus, a communication apparatus desired by the user, if present on the internet communication network, may not be automatically recognized using UPnP or SSDP.

This invention has been achieved in view of this background, and the object thereof is to provide a communication apparatus, a communication system and a program capable of automatic recognition between remote communication apparatuses using the SSDP packet according to the UPnP specification without changing the existing UPnP stack.

### SUMMARY OF THE INVENTION

According to the primary aspect of the invention, there is provided a primary communication apparatus comprising a data receiver connected to a communication network and adapted to receive the data from the communication network, a policy determining unit adapted to set the rule for determining the processing of the data received by the data receiver, a SSDP determining unit for determining the data processing with reference to the policy determining unit, a SSDP packet decapsulation unit adapted to process and decapsulate an encapsulated SSDP packet, a forwarding address list adapted to register the address of a remote communication apparatus, a SSDP packet encapsulation unit for processing and encapsulating the SSDP packet, and a remote apparatus information cache for storing the information on the remote communication apparatus.

In this primary communication apparatus having a program based on the UPnP specification, the policy determining unit sets the policy using the information contained in the SSDP packet, and the packet encapsulation unit encapsulates the SSDP packet.

In the aforementioned primary communication apparatus, the data cache holds the information contained in the SSDP packet.

According to another aspect of the invention, there is provided a communication system comprising at least an apparatus based on the UPnP specification and connected to a local network, a first communication apparatus connected to the local network, and another first communication apparatus connected to the local network through an internet communication network, wherein the first communication apparatus has the same configuration as the primary communication apparatus mentioned above.

According to still another aspect of the invention, there is provided a mutual recognition method for a communication system including an apparatus based on the UPnP specification connected to a local network, a first communication apparatus connected to the local network and another first communication apparatus connected to the local network through an internet communication network, wherein each of the first communication apparatuses receives a SSDP packet or an encapsulated SSDP packet, discards the packet upon determination that the received packet is not required, encapsulates the packet upon determination that the encapsulation is required and decapsulates the packet upon determination that the capsule is required to be decapsulated, and wherein the packet thus generated is transmitted to the communication system.

According to yet another aspect of the invention, there is provided a program for causing the computer connected to the communication network to execute the steps of receiving a SSDP packet or an encapsulated SSDP packet and determining whether the received packet is not required, required to be encapsulated or required to be decapsulated, discarding the packet upon determination that the packet is not required, encapsulating the packet upon determination that the packet is required to be encapsulated, decapsulating the packet upon determination that the packet is required to decapsulated, and transmitting the packet thus generated to the communication network.

According to a further aspect of the invention, there is provided a communication apparatus connected to a communication network adapted for communication using the SSDP packet and an internet communication network, comprising a data receiver adapted to receive the data from the communication network, a policy determining unit adapted to set the policy as to whether the data received by the data receiver is effective or not for the user, a data determining unit for determining a method of processing the data received by the data receiver, based on the policy set by the policy determining unit, a packet encapsulation unit for encapsulating the SSDP data received by the data receiver, into a packet communicable on the internet communication network, a packet decapsulation unit adapted to decapsulate the encapsulated data received by the data receiver into the original SSDP data, a forwarding address list adapted to hold the destination address required for encapsulation, a data cache adapted to hold the information acquired from the data produced by the decapsulation unit, and a data transmitter adapted to transmit the SSDP data to the communication network adapted for communication with the SSDP packet and transmit the encapsulated data to the communication network including the internet communication network.

This invention makes possible automatic recognition between remote communication apparatuses using SSDP, and a predetermined procedure defined by UPnP can be executed without changing the existing UPnP stack.

### BRIEF DESCRIPTION OF THE DRAWINGS

FIG. 1 is a diagram showing a general configuration of a communication system 1 according to an embodiment of the invention.

FIG. 2 is a diagram showing a hardware configuration of a communication apparatus 2 according to an embodiment of the invention.

FIG. 3 is a function block diagram showing the communication apparatus 2 according to an embodiment of the invention.

FIG. 4 is a diagram showing a data format of the encapsulated SSDP packet according to an embodiment of the invention.

FIG. 5 is a diagram for explaining the process flow for recognizing a remote one of the communication apparatuses 2 according to an embodiment of the invention.

FIG. 6 shows an example of a configuration (61) of a policy determining unit 32 according to an embodiment of the invention.

FIG. 7 shows an example of a configuration (71) of a forwarding address list 36 according to an embodiment of the invention.

FIG. 8 shows an example of a configuration (81) of a remote information cache 38 according to an embodiment of the invention.

### DESCRIPTION OF THE EMBODIMENTS

[System Configuration]

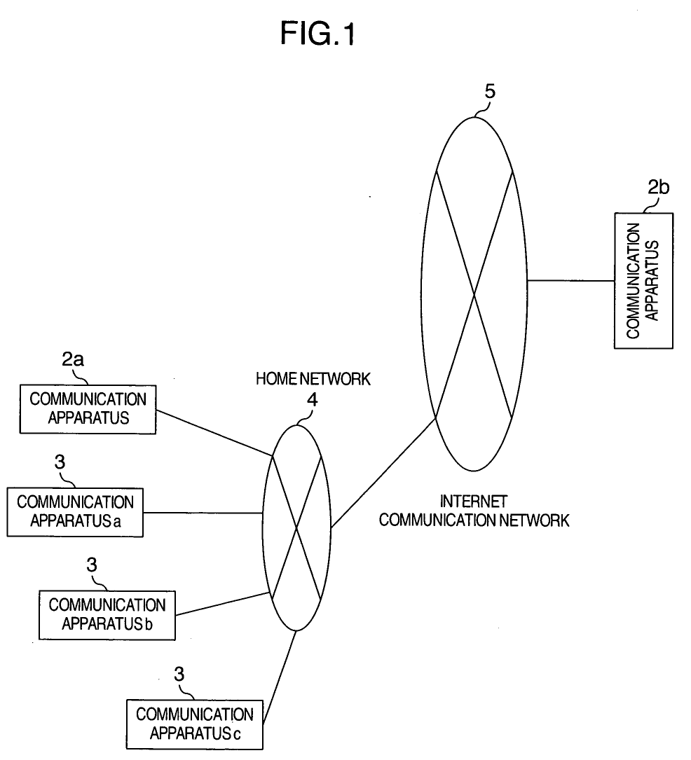

FIG. 1 shows an example of a configuration of a communication system 1 according to this embodiment. The communication system 1 includes a home network 4 connected with a communication apparatus 2a according to the invention and communication apparatuses 3, an internet communication network 5 connected with the home network 4, and a communication apparatus 2b according to the invention existing on the network 5. The network includes the home network 4 and the internet communication network 5. This embodiment assumes a case in which the communication apparatus 2a also has the function of a router making possible the communication between the internet communication network 5 and the home network 4.

The communication apparatuses 2a, 2b according to the invention and the communication apparatuses 3 are each, for example, a home electric appliance or a personal computer having the communication function. The communication apparatus 2a according to the invention and the communication apparatuses 3 are assumed to be connected to each other communicably through the home network 4. The home network 4 is constructed of a communication line such as Ethernet (registered trade mark), the telephone line, the lighting cable, wireless or infrared light. The home network 4 is connected to the internet communication network 5, and the communication apparatus 2b according to the invention existing on the internet communication network 5 distributes images and music or other contents, or otherwise provides various services including the disk space to the communication apparatus 2a and the communication apparatuses 3 on the home network 4.

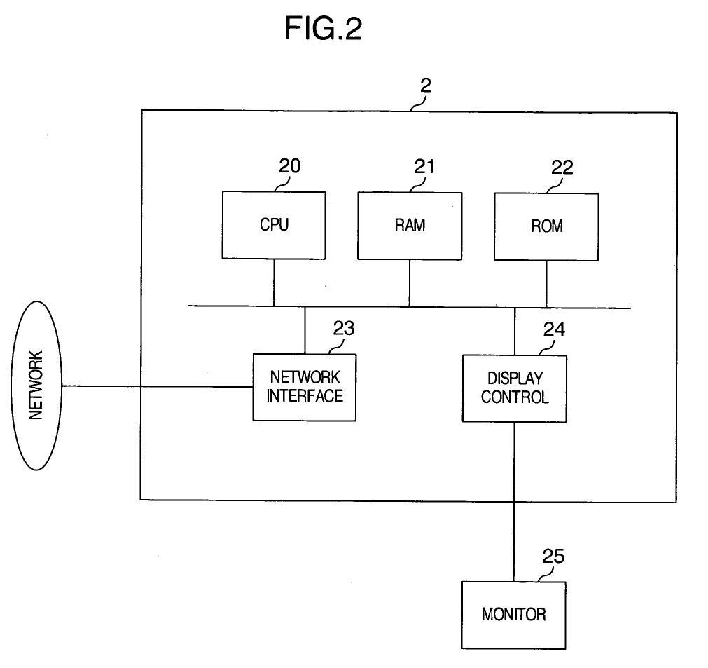

FIG. 2 shows an example of a hardware configuration of the communication apparatuses 2 according to this embodiment. The communication apparatuses 2 are each configured of a CPU 20 for controlling the whole communication apparatus 2, a RAM (random access memory) 21 and a ROM (read-only memory) 22 for storing data and programs, a network interface unit 23 for receiving the packets flowing in the network or sending out the packets to the network and thus transmitting and receiving the data with the communication apparatus 2 and the communication apparatuses 3 connected by the network, and a display control unit 24 for controlling the information display on a monitor 25 connected as an external device. The CPU 20 reads the program from the ROM 22 into the RAM 21 and executes it thereby to realize the various functions described later.

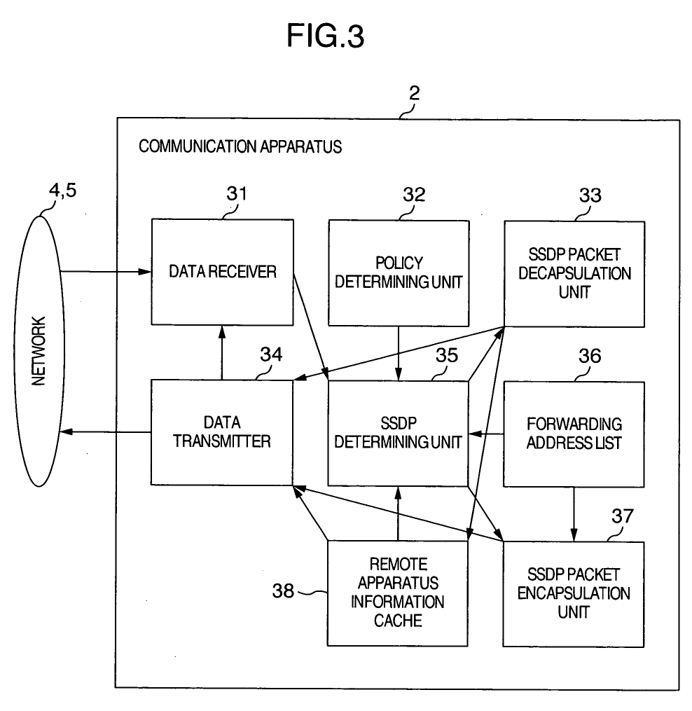

FIG. 3 is a function block diagram of the communication apparatus 2 according to the invention. The communication apparatus 2 includes a data receiver 31, a data transmitter 34, a policy determining unit 32, a SSDP determining unit 35, a SSDP packet encapsulation unit 37, a SSDP packet decapsulation unit 33, a forwarding address list 36, and a remote apparatus information cache 38. The data receiver 31, the data transmitter 34, the SSDP determining unit 35, the SSDP packet encapsulation unit 37 and the SSDP packet decapsulation unit 33 are implemented by the CPU 20 reading the program from the ROM. 22 into the RAM 21 and executing the program. The policy determining unit 32, the forwarding address list 36 and the remote information cache 38, on the other hand, are implemented in the storage area of the RAM 21.

In this specification, the term “encapsulation” is defined as the operation of converting the SSDP packet received from the home network 4 for multicast communication according to the UPnP protocol in-to a packet (such as an IP packet) that can be sent out to a communication network communicating with the internet communication network or the like using a different protocol.

The data receiver 31 receives the data from the communication apparatuses 2, 3 on the home network 4 (FIG. 1) or a host (communication apparatus 2b) on the internet communication network 5 by way of the network interface unit 23 (FIG. 2).

The policy determining unit 32 (FIG. 3) forms the policy for determining whether the SSDP packet received from the data receiver 31 is required to be transferred to the remote communication apparatus 2 or the encapsulated SSDP capsule is required to be decapsulated or the packet is required to be discarded, using the elements included in the SSDP packet such as the source hardware address, the source IP address, the destination IP address, the port number, the method name, the location, NT (notification type), NTS (notification subtype), USN (unique service name) and ST (search target).

An example of a configuration of the policy determining unit 32 is shown in FIG. 6. A SSDP packet to be accepted is described as ST: urn: schemas-upnp-prg: MediaServer: 1, and a SSDP packet to be denied as ST: urn: schemas-upnp-prg: MediaServer: 1, Src Addr: 100.100.100.100.

The SSDP determining unit (FIG. 3) determines, based on the description of the policy determining unit 32, whether the SSDP packet received from the data receiver 31 is to be encapsulated as an IP packet in the SSDP packet encapsulation unit 37 for transfer to the communication apparatus 2b on the internet communication network 5, or the encapsulated SSDP packet received from the data receiver 31 is to be decapsulated into the SSDP packet by the SSDP packet decapsulation unit 33 or the data is to be discarded.

Upon determination by the SSDP determining unit 35 that the encapsulated SSDP packet is required to be decapsulated, the SSDP packet decapsulation unit 33 executes the process of decapsulating the encapsulated SSDP packet. Specifically, the data portion of the encapsulated packet are extracted and returned to the SSDP packet.

The IP packet transmissible on the internet communication network into which the SSDP packet communicable on the home network 4 is converted by the SSDP packet encapsulation unit 37 can be transmitted by the data transmitter 34 as a data to the host on the internet communication network through the network interface unit 23 (FIG. 2). Also, the SSDP packet received by the data receiver 31 from the internet communication network 5 and converted into a SSDP packet by the SSDP packet decapsulation unit 33 can be transmitted by the data transmitter 34 (FIG. 3) to the home network 4.

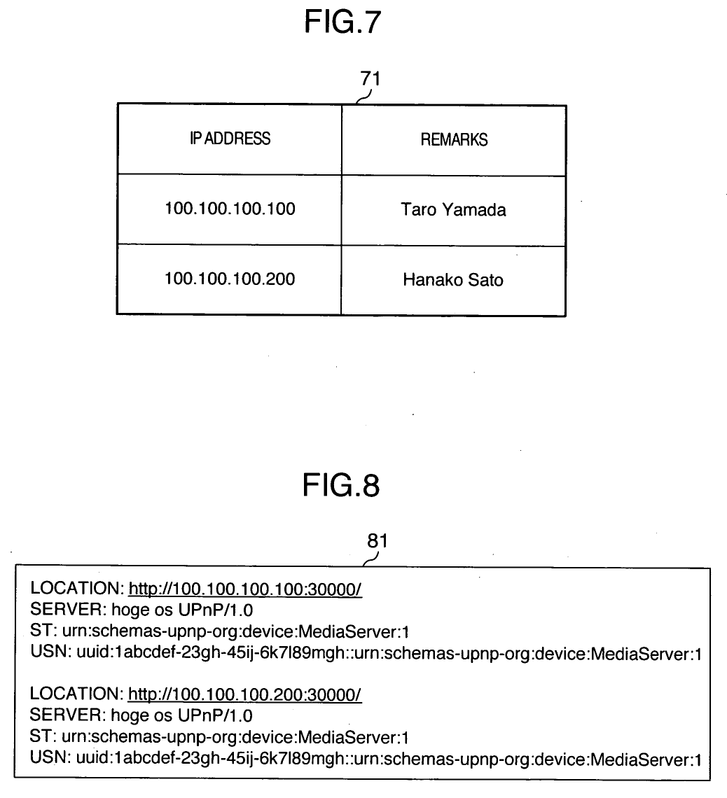

The forwarding address list 36 holds the address of the destination communication apparatus 2b to transfer the encapsulated SSDP packet to the remote communication apparatus 2. The address of this destination communication apparatus 2, if informed of in advance, can be registered, or can be determined by the source IP address of the encapsulated SSDP packet transferred from the remote communication apparatus 2. An example of the configuration of the forwarding address list 36 is shown in FIG. 7 in which the destination IP address such as a name is added as a remark to each source transmission apparatus.

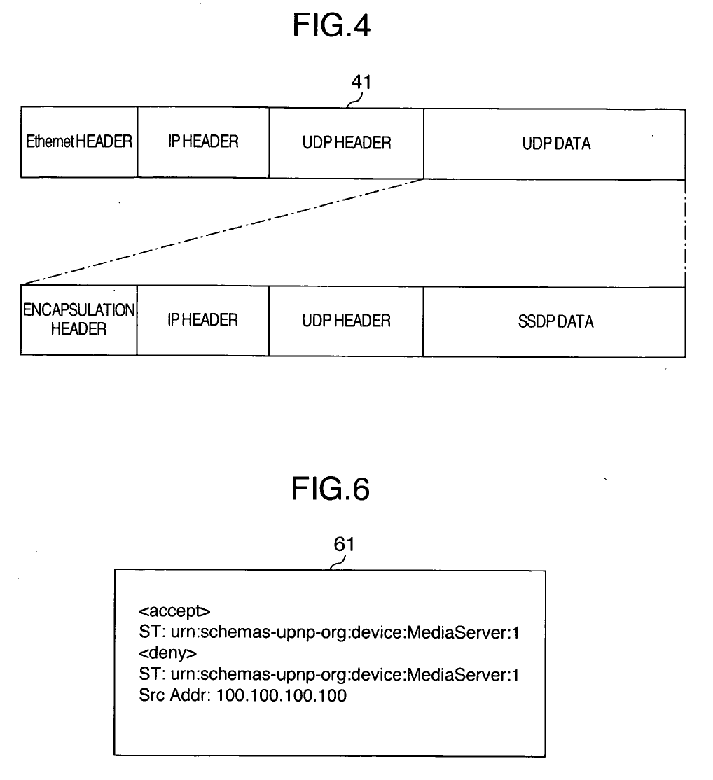

In the SSDP packet encapsulation unit 37, the encapsulation header is added to the SSDP packet determined for encapsulation by the SSDP determining unit 35, and to the resulting UDP data, the UDP header, the IP header and the Ethernet (registered trade mark) header are added thereby to generate an IP packet as an encapsulated packet. In this way, the packet to be sent to the address (described in the IP header) acquired from the forwarding address list 36 is generated. For example, the encapsulated SSDP packet assumes the data format shown in FIG. 4, and the SSDP encapsulation unit 37 (FIG. 3) executes the process of converting the header in the packet.

The encapsulated SSDP packet is constituted as an IP packet 41 (FIG. 4), for example, with the Ethernet header, the IP header, the UDP header or the UDP data, which in turn is constituted by adding the encapsulation header to the SSDP packet including the IP header, the UDP header and the SSDP data.

The remote apparatus information cache 38 (FIG. 3) stores the information of the remote communication apparatus 2 acquired by a series of processes according to the invention. An example of the configuration of the remote information cache 38 is shown in FIG. 8.

FIG. 4 shows a data format of the encapsulated SSDP packet. The normal SSDP packet is encapsulated with the header (encapsulation header) indicating that the packet is encapsulated in accordance with the procedure according to the invention, the transport layer (UDP header, IP header) and the protocol of the network layer (Ethernet (registered trade name) header).

[Recognition Process]

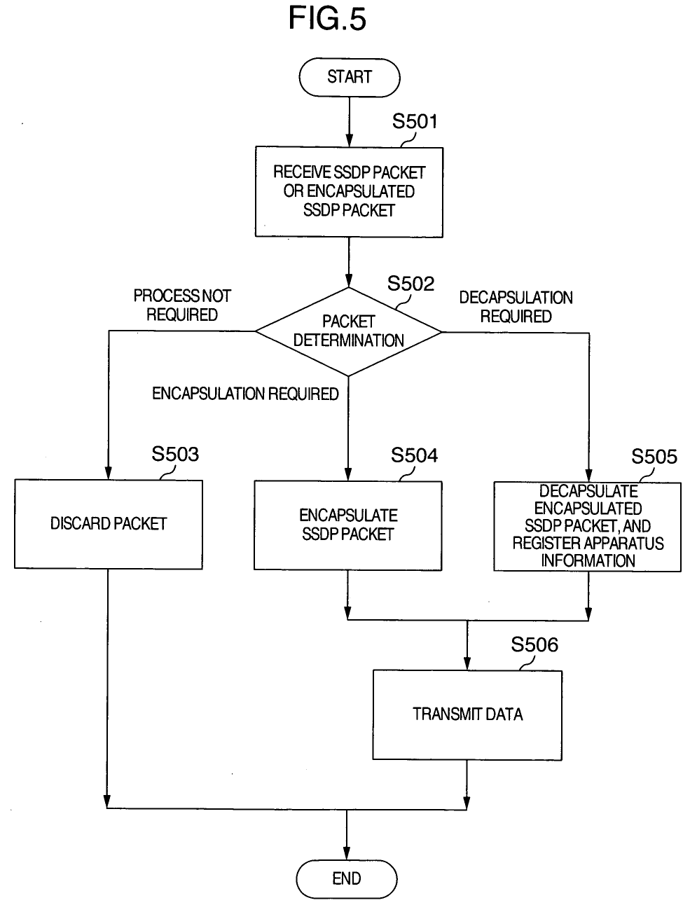

A method of recognizing the remote communication apparatus 2b (FIG. 1) included in the communication apparatuses 2 according to this embodiment using SSDP is explained below in detail with reference to FIG. 5. FIG. 5 is a diagram for explaining the process flow for mutual recognition between the communication apparatus 2a and the remote communication apparatus 2b.

The communication apparatus 2a waits for the SSDP packet received from the local network (home network) by the data receiver 31 or the encapsulated SSDP packet received through the internet communication network 5 (S501).

The policy determining unit 32, upon receipt of the packet at step S501, determines whether the packet is required to be encapsulated for transfer, required to be decapsulated for transfer into the home network or not required to be processed, with reference to the policy determining unit 32 (S502). Upon determination that the received packet is the SSDP packet and required to be transferred to the remote communication apparatus 2b, the process proceeds to step S504, while upon determination that the received packet is the encapsulated SSDP packet and required to be decapsulated, on the other hand, the process proceeds to step S505. The SSDP packet or the encapsulated SSDP packet determined by the policy determining unit 32 that no process is required on is discarded (S503).

At step S504, the SSDP packet received from the home network 4, to transfer it to the remote communication apparatus 2b, is encapsulated into an IP packet having the data format shown in FIG. 4 with reference to the forwarding address list 36, and the process proceeds to step S506.

At step S505, the encapsulated SSDP packet received as an IP packet through the internet communication network 5 is decapsulated into the SSDP packet format, and the apparatus information of the remote communication apparatus 2 is registered in the remote apparatus information cache 38, followed by proceeding to step S506.

At step S506, the packet processed at step S504 or S505 is transmitted to the home network 4 or the internet communication network 5 using the data transmitter 34.

[Specific Example of Recognition Process]

With reference to FIG. 1, a specific example of the method of recognizing the remote communication apparatus 2b using SSDP is explained. To simplify the explanation, the communication apparatuses 2a, 2b are assumed to have a global IP address and the communication apparatuses 3 a private IP address. SSDP includes a method called M-SEARCH to make an inquiry about the communication apparatuses providing the service by multicasting and a method called NOTIFY which notifies the presence of oneself by multicasting.

[First Specific Example of Process]

The process flow for the communication apparatus 2a to recognize the presence of the remote communication apparatus 2b is described. The communication apparatuses 2a, 2b are assumed to have the configuration shown in FIGS. 2 and 3, respectively. The communication apparatus 2a issues M-SEARCH to recognize the communication apparatus 3 in the home network 4 to which the communication 2a belongs. Then, the SSDP determining unit 35 determines (“encapsulation required” at S502) the M-SEARCH received (S501) by the data receiver 31 of the communication apparatus 2a, after which the SSDP packet is encapsulated (S504) by the SSDP encapsulation unit 37. The source IP address described in the IP header of the encapsulated SSDP packet constitutes the IP address of the communication apparatus 2a, so that the SSDP packet is encapsulated into an IP packet having the IP address of the communication apparatus 2b as a destination IP address of the IP packet using the forwarding address list 36. After that, the encapsulated SSDP packet is transmitted to the communication apparatus 2b (S506).

In the communication apparatus 2b, the SSDP determining unit 35 determines (S502) the encapsulated SSDP packet received (S501), after which the SSDP packet decapsulation unit 33 decapsulates the packet (S505). The SSDP packet decapsulated is transmitted by the data transmitter 34 (S506). The UPnP stack of the communication apparatus 2b that has received the data unicasts the response to the global IP address of the communication apparatus 2a constituting the source IP address of the decapsulated SSDP packet. As a result, the communication apparatus 2a comes to recognize the presence of the remote communication apparatus 2b. The information of the communication apparatus 2b that has been grasped is registered in the remote apparatus information cache 38 of the communication apparatus 2a (S505).

[Second Specific Example of Process]

The process flow in which the communication apparatus 2a causes the presence thereof to be recognized by the remote communication apparatus 2b is explained. The communication apparatus 2a issues NOTIFY to recognize the presence thereof to the home network 4 to which the communication apparatus 2a belongs. The NOTIFY of SSDP transmitted by the communication apparatus 2a to the home network 4 using the multicast address of 239.255.255.250 is received by the data receiver 31 of the communication apparatus 2a (S501). In the case where the SSDP determining unit 35 determines that the transfer to the communication apparatus 2b is required (“encapsulation required” at S502), the SSDP packet encapsulation unit 37 encapsulates the SSDP packet into an IP packet of the format shown in FIG. 4 using the IP address in the IP header of the IP packet 41 of the communication apparatus 2b as a destination address and the IP address of the very communication apparatus 2a as a source address with reference to the forwarding address list 36 (S504). The NOTIFY of SSDP of the encapsulated packet is transmitted to the network by the data transmitter 34 (S506) and reaches the communication apparatus 2b.

In the communication apparatus 2b, the data receiver 31 receives the packet (S501), the SSDP determining unit 34 determines that the process is required based on the determination in the policy determining unit 32 (S502), and the SSDP packet decapsulation unit 33 decapsulates the encapsulated SSDP packet (S505) into the normal SSDP packet. The SSDP packet thus decapsulated is transmitted by the data transmitter 34 of the communication apparatus 2b to the network to which the communication apparatus 2b belongs (S506). The UPnP stack of the communication apparatus 2b that has received the packet (S501) recognizes the presence of the communication apparatus 2a. The communication apparatus 2b, after recognizing the presence of the communication apparatus 2a, can execute the various processes in accordance with the normal UPnP process flow.

[Third Specific Example of Process]

The process flow in which the communication apparatus 2b recognizes the presence of the remote communication apparatus 2a is described. In order to grasp the resources of the network to which the communication apparatus 2b belongs, the communication apparatus 2b issues M-SEARCH of SSDP. The M-SEARCH of SSDP transmitted by the communication apparatus 2b to the network associated therewith using the multicast address of 239.255.255.250 is received by the data receiver 31 of the communication apparatus 2b (S501). In the case where the SSDP determining unit 35 determines, with reference to the policy determining unit 32, that the transfer is required to the communication apparatus 2a or the network to which the communication apparatus 2a belongs (“encapsulation required” at step S502), the SSDP packet is encapsulated by the SSDP packet encapsulation unit 37 with the IP address of the communication apparatus 2a as a destination address and the IP address of the communication apparatus 2b as a source address with reference to the forwarding address list 36 (S504). The M-SEARCH of the encapsulated SSDP is transmitted to the network by the data transmitter 34 (S506) and reaches the communication apparatus 2a.

In the communication apparatus 2a, the data receiver 31 receives the packet (S501), the SSDP determining unit 34 determines whether the process is required with reference to the policy determining unit 32 (“decapsulation required” at step S502), and the SSDP packet decapsulation unit 32 decapsulates the encapsulated SSDP packet (S505) into the normal SSDP packet. This packet is transmitted by the data transmitter 34 of the communication apparatus 2a to the home network to which the communication apparatus 2a belongs (S506). The UPnP stack of the communication apparatus 2a that has received the packet recognizes the presence of the communication apparatus 2b, and can respond to the M-SEARCH of the communication apparatus 2b.

Any of the communication apparatuses 3, upon receipt of the packet, recognizes the presence of the communication apparatus 2b and can respond to the M-SEARCH. Since the information of the local address of the communication apparatus 3 is incorporated into the SSDP data portion of the response shown in FIG. 4, however, the response is discarded by the SSDP determining unit 35 of the communication apparatus 2a as a router connected to the internet communication network 5, and fails to reach the M-SEARCH of the communication apparatus 2b. As a result, the network configuration in the home network 4 and the presence of the communication apparatus 3 are hidden from the communication apparatus 2b desirably for security and privacy protection.

As an alternative, the response is given by the communication apparatus 3 to the M-SEARCH of the communication apparatus 2b, and discarded by the SSDP determining unit 35 of the communication apparatus 2b. This also applies to the case in which the communication apparatuses 3 have a global IP.

[Fourth Specific Example of Process]

The process flow in which the communication apparatus 2b causes the presence thereof to be recognized by the remote communication apparatus 2a and the communication apparatuses 3 is explained. In order to cause the presence thereof to be recognized, the communication apparatus 2b issues NOTIFY of SSDP to the network to which the communication apparatus 2b belongs. The NOTIFY of the SSDP packet transmitted by the communication apparatus 2b to the network to which the communication apparatus 2b belongs, using the multicast address of 239.255.255.250 is received by the data receiver 31 of the communication apparatus 2b (S501). In the case where the SSDP determining unit 35 determines, with reference to the policy determining unit 32, that the transfer to the communication apparatus 2a or the home network to which the communication apparatus 2a belongs is required (“encapsulation required” at step S502), the packet is encapsulated by the SSDP packet encapsulation unit 37 into the format shown in FIG. 4 using the IP address of the communication apparatus 2a as a destination address and the source address as an IP address of the communication apparatus 2b with reference to the forwarding address list 36 (S504). The NOTIFY of the SSDP packet encapsulated is transmitted by the data transmitter 34 to the internet communication network 5 (S506) and reaches the communication apparatus 2a.

In the communication apparatus 2a, the data receiver 31 receives the packet (S501), the SSDP determining unit 34 determines whether the process is required or not with reference to the policy determining unit 32 (“decapsulation required” at step S502), and the SSDP packet decapsulation unit 32 decapsulates the encapsulated SSDP packet (S505) into the normal SSDP packet. This packet is transmitted by the data transmitter 34 of the communication apparatus 2a to the home network to which the communication apparatus 2a belongs (S506). The UPnP stack of the communication apparatus 2a that has received the packet can recognize the presence of the communication apparatus 2b. Also, the communication apparatus 2a registers the information of the communication apparatus 2b in the remote apparatus information cache 38 (S505). Further, the communication apparatuses 3 belonging to the home network 4, upon receipt of the packet, can grasp the presence of the communication apparatus 2b. This also applies to the case in which the communication apparatuses 3 have a global IP.

[Fifth Specific Example of Process]

The process flow in which the communication apparatuses 3 recognize the presence of the remote communication apparatus 2b is described. A communication apparatus 3 issues the M-SEARCH of SSDP to recognize other communication apparatus 3 or the communication apparatus 2a existing in the home network 4 to which the communication apparatuses 3 belong. The UPnP stack of the communication apparatus 2a that has received the M-SEARCH of SSDP transmitted by the communication apparatus 3 returns the response containing the apparatus information of the communication apparatus 2a to the communication apparatus 3 in accordance with SSDP scheme. The apparatus information of the communication apparatus 2b registered in the remote apparatus information cache 38 is also given as a response in the SSDP data format by the communication apparatus 2a. As a result, the communication apparatuses 3 can recognize the presence of the communication apparatus 2b through the communication apparatus 2a. This applies also to the case in which the communication apparatuses 3 have a global IP.

[Sixth Specific Example of Process]

The process flow in which the communication apparatuses 3 cause the presence thereof to be recognized by the remote communication apparatus 2b is described below. Any of the communication apparatuses 3 issues the NOTIFY of SSDP to recognize the presence of the communication apparatus 3 to the other communication apparatuses 3 and the communication apparatus 2a existing in the home network 4 to which the particular communication apparatus 3 belongs. The communication apparatus 2a which has received the packet through the data receiver 31, upon determination by the SSDP determining unit 35 that the packet is not to be transferred to the communication apparatus 2b with reference to the policy determining unit 32, discards the packet. This is by reason of the fact that the communication apparatus 3 is the local address and this information is contained in the SSDP data field shown in FIG. 4. The transfer of the NOTIFY packet having this SSDP data field to the communication apparatus 2b, therefore, is meaningless. This also prevents the communication apparatus 2b from receiving many NOTIFY packets. The same applies to the case in which the communication apparatuses 3 have a global IP.

In this way, the remote communication apparatus 2b, the communication apparatus 2a and the communication apparatuses 3 can recognize the presence of each other.

[Modification]

According to this embodiment, the SSDP packet encapsulated by the SSDP encapsulation unit 37 has a data format as shown in FIG. 4. As an alternative, the UDP data field is sent out by being converted by a reversible conversion method and the receiver may restore it to the original UDP data field in the form before conversion by the transmitter. The conversion method includes encryption and compression. As a result, the eavesdropping of the data flowing between the communication apparatuses 2 becomes difficult and the communication traffic can be reduced.

The transport layer of the SSDP packet encapsulated by the SSDP packet encapsulation unit 37 may be TCP instead of UDP. By encapsulating the SSDP packet by TCP, the reliablity of data reachability between the communication apparatuses 2 is improved.

Also, the UDP data field of the SSDP packet encapsulated by the SSDP encapsulation unit 37 may be encapsulated from the data of the data link layer instead of from the data of the network layer.

The encapsulated SSDP packet transmitted from the remote communication apparatus 2b is decapsulated by the SSDP packet decapsulation unit 33, and transmitted by the data transmitter 34 onto the network to which the communication apparatus 2a belongs. As an alternative, the communication apparatus 2a may use the data within itself without transmission to the network. In this case, the SSDP packet is not transferred from the communication apparatus 2b to the communication apparatuses 3 existing in the network to which the communication apparatus 2a belongs, and therefore no great amount of unrequired responses are received by the communication apparatus 2b from the communication apparatuses 3.

According to the invention, as described above, the communication apparatus 2a connected to the home network 4 of UPnP specification has the dual function of conducting the communication using the SSDP packet within the home network and communicating with the internet communication network 5 using the IP packet at the same time. On the other hand, assume that the communication apparatus 2a is a router connected to the home network 4, which conducts communication with the home network using the SSDP packet and communicates with the internet communication network using the IP packet. Then, upon receipt of the SSDP packet multicast from the communication apparatuses 3 connected to the home network 4, the communication apparatus 2a determines whether this packet is to be encapsulated or not and in the case where the encapsulation is required, the SSDP packet is encapsulated into an IP packet and sent out to the internet communication network 5, thereby making possible the communication with the remote communication apparatus 2b.

Upon receipt of an encapsulated SSDP packet from the remote communication apparatus 2b through the internet communication network 5, on the other hand, the SSDP determining unit 36 determines whether the decapsulation process is required or not, and in the case where the decapsulation is required, the SSDP packet encapsulated with the IP address is decapsulated into the normal SSDP packet and transmitted to the destination communication apparatus 3 by multicasting.

Having described a preferred embodiment of the invention with reference to the accompanying drawings, it is to be understood that the invention is not limited to the embodiments and that various changes and modifications could be effected therein by one skilled in the art without departing from the spirit and scope of the invention as defined in the appended claims.

1. A communication apparatus coupled to a communication network, comprising:
a data receiver adapted to receive the data from the communication network;
a policy determining unit adapted to set a policy as to whether the data received by the data receiver is effective to the user;
a data determining unit for determining the method of processing the data received by the data receiver, based on the policy set by the policy determining unit;
a packet encapsulation unit for encapsulating the data received by the data receiver;
a decapsulation unit adapted to decapsulate the encapsulated data into the original data;
a forwarding address list adapted to hold the destination address required for encapsulation by the packet encapsulation unit;
a data cache adapted to hold the information acquired from the data produced from the decapsulation unit; and
a data transmitter adapted to transmit the data to the communication network.

2. A communication apparatus according to claim 1, having a program based on the UPnP specification.

3. A communication apparatus according to claim 1, wherein the policy determining unit sets a policy using the information contained in the SSDP packet.

4. A communication apparatus according to claim 1, wherein the packet encapsulation unit encapsulates the SSDP packet.

5. A communication apparatus according to claim 1, wherein the data cache holds the information contained in the SSDP packet.

6. A communication system comprising:
an apparatus based on the UPnP specification connected to the local network;
a first communication apparatus connected to the local network; and
a first communication apparatus connected to the local network through an internet communication network,
wherein the first communication apparatuses each includes:
a data receiver adapted to receive the data from the communication network;
a policy determining unit adapted to set a policy as to whether the data received by the data receiver is effective to the user;
a data determining unit for determining the method of processing the data received by the data receiver, based on the policy set by the policy determining unit;
a packet encapsulation unit for encapsulating the data received by the data receiver;
a decapsulation unit adapted to decapsulate the encapsulated data into the original data;
a forwarding address list adapted to hold the destination address required for encapsulation by the packet encapsulation unit;
a data cache adapted to hold the information acquired from the data produced by the decapsulation unit; and
a data transmitter adapted to transmit the data to the communication network.

7. A one-another recognition method in a communication system having:
an apparatus based on the UPnP specification and connected to the local network;
a first communication apparatus connected to the local network; and
a first communication apparatus connected to the local network through an internet communication network;
said first communication apparatuses are each adapted to execute:
the first step of receiving selected one of a SSDP packet and an encapsulated SSDP packet;
the second step of discarding the packet upon determination that the received packet is not required, encapsulating the packet upon determination that the capsulation is required, and decapsulating the packet upon determination that the decapsulation is required; and
the third step of transmitting the result of execution of the second step to the communication system.

8. A program making a computer coupled to a communication network to execute:
the first step of receiving selected one of a SSDP packet and an encapsulated SSDP packet;
the second step of determining whether the received packet is not required, required to be encapsulated or required to be decapsulated;
the third step of discarding the packet upon determination that the packet is not required;
the fourth step of encapsulating the packet upon determination that the packet is required to be encapsulated;
the fifth step of decapsulating the packet upon determination that the packet is required to decapsulated; and
the sixth step of transmitting the result of the process executed in selected one of the fourth step and the fifth step to the communication network.

9. A communication apparatus coupled to a communication network under SSDP scheme by way of an internet communication network, comprising:
a data receiver adapted to receive the data from the communication network;
a policy determining unit adapted to set a policy as to whether the data received by the data receiver is effective or not for the user;
a data determining unit for determining the method of processing the data received by the data receiver, based on the policy set by the policy determining unit;
a packet encapsulation unit for encapsulating the SSDP data received by the data receiver into a packet communicable on the internet communication network;
a packet decapsulation unit adapted to decapsulate the encapsulated data received by the data receiver and restoring the original SSDP data;
a forwarding address list adapted to hold the destination addresses required for encapsulation by the packet encapsulation unit;
a data cache adapted to hold the information acquired from the data produced by the decapsulation unit; and
a data transmitter adapted to transmit the SSDP data to the communication network for communication using the SSDP packet and transmit the encapsulated data to the communication network including the internet communication network.
